(19) United States
(12) Patent Application Publication
(10) Pub. No.: US 2023/0419202 A1
(43) Pub. Date: Dec. 28, 2023

(54) METHODS, INTERNET OF THINGS (IoT) SYSTEMS, AND MEDIUMS FOR MANAGING TIMELINESS OF SMART GAS DATA

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei HE, Chengdu (CN)

(73) Assignee: CHENGDU QINCHUAN IOT TECHNOLOGY CO., LTD., Chengdu (CN)

(21) Appl. No.: 18/464,307

(22) Filed: Sep. 11, 2023

(30) Foreign Application Priority Data
Jul. 28, 2023 (CN) 202310937157.6

(51) Int. Cl. G06Q 10/063; G16Y 10/35; G16Y 40/20; G16Y 40/35

(52) U.S. Cl. CPC G06Q 10/063; G16Y 10/35; G16Y 40/20; G16Y 40/35

(57) ABSTRACT

Methods, Internet of Things (IoT) systems, and mediums for managing timeliness of smart gas data are provided. The method includes obtaining at least one piece of gas data of the smart gas data center periodically; for any one of the at least one piece of gas data, determining a data type of the gas data based on a historical fluctuation of the gas data, and categorizing and storing the gas data based on the data type; determining a timeliness feature of the gas data based on the data type and an information feature of the gas data; determining an analytical requirement score of the gas data based on a distributional feature of the gas data; determining an execution feature of the smart gas data center based on the timeliness feature of the at least one piece of gas data and the analytical requirement score of the at least one piece of gas data.

### CROSS-REFERENCE TO RELATED APPLICATION

This application claims priority of Chinese Patent Application No. 202310937157.6, filed on Jul. 28, 2023, the contents of which are entirely incorporated herein by reference.

### TECHNICAL FIELD

The present disclosure relates to the technical field of the Internet of Things (IoT), and in particular, to methods, IoT systems, and mediums for managing timeliness of smart gas data.

### BACKGROUND

With a rapid development of an urban gas industry, gas operating companies usually configure smart gas data centers to receive or send large amount of gas data, and analyze and process gas data. However, different gas data has different timeliness and processing priorities. If these large amount of extensive gas data is not analyzed for timeliness, a processing efficiency of the smart gas data center may be affected, which in turn affects timeliness of an operation, such as subsequent gas work order distribution or gas anomaly notification, thereby causing a decrease in an experience degree of a gas user, even affecting timely handling of a gas emergency to cause a serious consequence.

To address the above problem, CN111125787B proposes systems for blockchain-based gas inspection data cochain and methods thereof. CN111125787B stores the gas inspection data in a blockchain distributed ledger through smart contracts by forming a blockchain network to synchronize the data of various relevant departments in real time and avoid tampering with the inspection data. However, the processing efficiency of gas data is not involved and the timeliness of gas data processing is not ensured.

Therefore, it is desirable to provide methods, Internet of Things (IoT) systems, and mediums for managing timeliness of smart gas data. An execution feature of the smart gas data center is determined, which is conducive to improving the data processing efficiency of the smart gas data center.

### SUMMARY

One of the embodiments of the present disclosure provides a method for managing timeliness of smart gas data. The method is performed by a smart gas data center and the method includes obtaining at least one piece of gas data of the smart gas data center periodically, and for any one of the at least one piece of gas data, determining a data type of the gas data based on a historical fluctuation of the gas data, and categorizing and storing the gas data based on the data type. The data type includes static gas data and dynamic gas data. The method also includes determining a timeliness feature of the gas data based on the data type and an information feature of the gas data. The timeliness feature indicates an importance degree of the gas data at different time points. The method also includes determining an analytical requirement score of the gas data based on a distributional feature of the gas data. The distributional feature at least includes a dispersion degree and a concentration degree of the gas data. The method further includes determining an execution feature of the smart gas data center based on the timeliness feature of the at least one piece of gas data and the analytical requirement score of the at least one piece of gas data. The execution feature includes estimated transmission data transmitted by the smart gas data center to at least one gas platform and an estimated transmission time of the estimated transmission data, and the at least one gas platform includes a smart gas service platform, a smart gas sensor network platform, or a smart gas management platform.

One of the embodiments of the present disclosure provides an Internet of Things (IoT) system for managing timeliness of smart gas data. The system includes a smart gas user platform, a smart gas service platform, a smart gas management platform, a smart gas sensor network platform, and a smart gas object platform interacting in sequence. The smart gas management platform includes a smart gas data center, and the smart gas data center is configured to obtain at least one piece of gas data of the smart gas data center periodically, and for any one of the at least one piece of gas data, determine a data type of the gas data based on a historical fluctuation of the gas data, and categorize and store the gas data based on the data type. The data type includes static gas data and dynamic gas data. The smart gas data center is configured to determine a timeliness feature of the gas data based on the data type, an information feature of the gas data. The timeliness feature indicates an importance degree of the gas data at different time points. The smart gas data center is further configured to determine an analytical requirement score of the gas data based on a distributional feature of the gas data. The distributional feature at least includes a dispersion degree and a concentration degree of the gas data. The smart gas data center is further configured to determine an execution feature of the smart gas data center based on the timeliness feature of the at least one piece of gas data and the analytical requirement score of the at least one piece of gas data. The execution feature includes estimated transmission data transmitted by the smart gas data center to at least one gas platform and an estimated transmission time of the estimated transmission data, and the at least one gas platform includes the smart gas service platform, the smart gas sensor network platform, or the smart gas management platform.

One of the embodiments of the present disclosure provides a non-transitory computer-readable storage medium storing computer instructions. When a computer reads the computer instructions in the storage medium, the computer executes a method for managing timeliness of smart gas data.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a diagram illustrating an exemplary platform structure of an Internet of Things (IoT) system for managing timeliness of smart gas data according to some embodiments of the present disclosure;

FIG. 2 is a flowchart illustrating an exemplary process of a method for managing timeliness of smart gas data according to some embodiments of the present disclosure;

FIG. 3 is an exemplary schematic diagram illustrating a process of generating a timeliness feature based on a timeliness feature determination model according to some embodiments of the present disclosure; and

FIG. 4 is an exemplary schematic diagram illustrating a process of generating an execution feature based on an execution feature determination model according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. The drawings described below are only some examples or embodiments of the present disclosure.

The singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

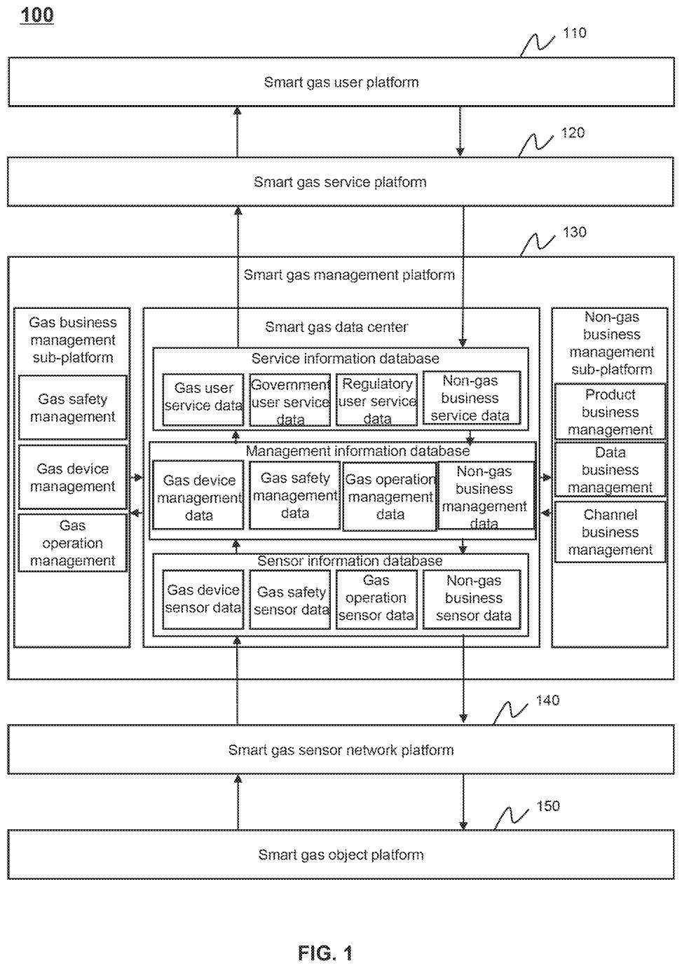

FIG. 1 is a diagram illustrating an exemplary platform structure of an Internet of Things (IoT) system for managing timeliness of smart gas data according to some embodiments of the present disclosure. The IoT system for managing timeliness of smart gas data involved in the embodiments of the present disclosure is described in detail as follows. It should be noted that the following embodiments are only intended to explain the present disclosure and do not limit the present disclosure.

A smart gas user platform 110 is a platform used to interact with a user. In some embodiments, the smart gas user platform 110 may be configured as a terminal device.

A smart gas service platform 120 is a platform used to convey a requirement of the user and control information. The smart gas service platform 120 may obtain gas data from a smart gas management platform 130 (e.g., a smart gas data center) and send the gas data to the smart gas user platform 110.

The smart gas management platform 130 is a platform that coordinates or plans a connection and a collaboration between various functional platforms as a whole, gathers information of the IoT, and provides perception management and control management functions for an IoT operating system.

The smart gas management platform 130 includes a gas business management sub-platform, a non-gas business management sub-platform, and a smart gas data center. The gas business management sub-platform is used for gas safety management, gas device management, and gas operation management. The non-gas business management sub-platform is used for product business management, data business management, and channel business management.

In some embodiments, the smart gas management platform 130 may interact with the smart gas service platform 120 and the smart gas sensor network platform 140 through the smart gas data center, respectively. For example, the smart gas data center may send gas operation data and/or gas management data to the smart gas service platform 120. As another example, the smart gas data center may send an instruction for obtaining gas data to a smart gas sensor network platform 140 to obtain static gas data and/or dynamic gas data.

The smart gas data center includes a service information database, a management information database, and a sensor information database. The service information database interacts with the smart gas service platform in two directions, the management information database interacts with the gas business management sub-platform in two directions, the management information database interacts with the non-gas business management sub-platform in two directions, and the sensor information database interacts with the smart gas sensor network platform in two directions. The service information database includes gas user service data, government user service data, regulatory user service data, and non-gas business service data. The management information database includes gas device management data, gas safety management data, gas operation management data, and non-gas business management data. The sensor information database includes gas device sensor data, gas safety sensor data, gas operation sensor data, and non-gas business sensor data.

The smart gas sensor network platform 140 is a functional platform for managing sensor communication. In some embodiments, the smart gas sensor network platform 140 may realize functions of perceptual information sensor communication and control information sensor communication.

In some embodiments, the smart gas sensor network platform 140 may be used to interact with the smart gas data center and a smart gas object platform 150.

The smart gas object platform 150 may be a functional platform for perceptual information generation and control information execution. In some embodiments, the smart gas object platform 150 may be configured as a plurality of types of gas and monitoring devices. The monitoring devices may include a gas flow device, an image obtaining device, a temperature and humidity sensor, a pressure sensor, a gas leakage alarm, etc.

In some embodiments, the smart gas object platform 150 may be used to periodically obtain at least one piece of gas data.

In some embodiments of the present disclosure, based on the IoT system 100 for managing timeliness of smart gas data, a closed loop of information operation may be formed between the smart gas object platform 150 and the smart gas user platform 110. The closed loop operates in a coordinated and regular manner under unified management of the smart gas data center of the smart gas management platform 130, so as to realize informatization and intellectualization of timeliness management of the gas data.

It should be noted that the above descriptions of the IoT system 100 for managing of timeliness of smart gas data and components thereof is merely for the purposes of illustration and does not limit the present disclosure to the scope of the embodiments. It should be understood that for those skilled in the art, after understanding the principle of the system, it is possible to arbitrarily combine various components without deviating from the principle, or form a sub-system connected with other components.

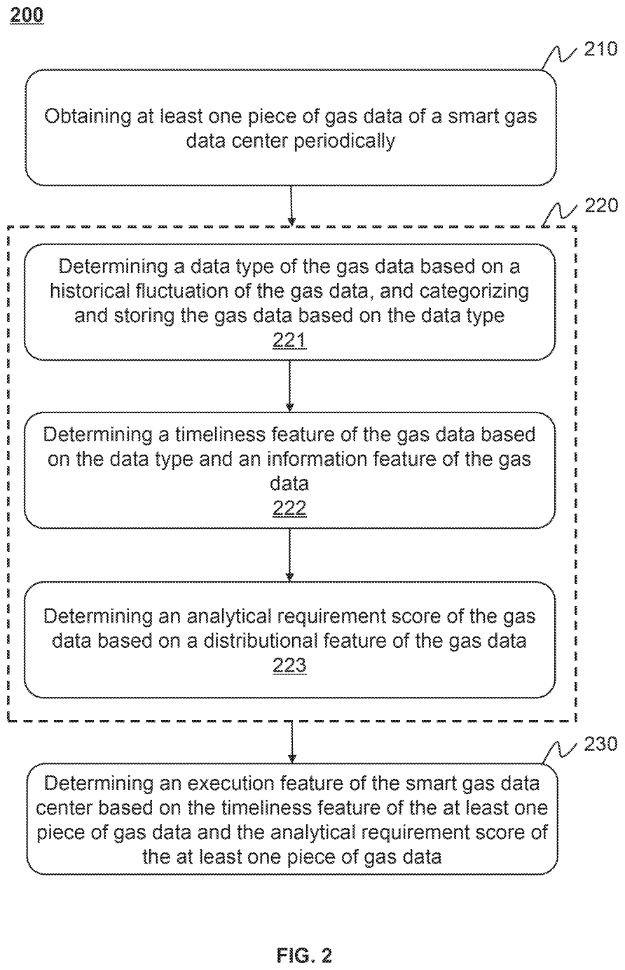

FIG. 2 is a flowchart illustrating an exemplary process of a method for managing timeliness of smart gas data according to some embodiments of the present disclosure. In some embodiments, the process 200 may be performed by a smart gas data center. As shown in FIG. 2, the process 200 includes the following operation.

In 210, obtaining at least one piece of gas data of the smart gas data center periodically.

More detailed descriptions regarding the smart gas data center may be found in FIG. 1 and relevant descriptions thereof.

The gas data refers to gas-related data in the IoT system 100 for managing timeliness of smart gas data. For example, the gas data may include user repair information obtained by the smart gas user platform 110, gas flow obtained by the smart gas object platform 150, etc.

In some embodiments, the smart gas data center may obtain the gas data thereof periodically.

In 220, for any one of the at least one piece of gas data, determining a timeliness feature and an analytical requirement score of the gas data. The determination of the timeliness feature and analytical requirement score of any one piece of gas data may include the following operations.

In 221, determining a data type of the gas data based on a historical fluctuation of the gas data, and categorizing and storing the gas data based on the data type.

The historical fluctuation refers to a degree to which the gas data fluctuates and changes. In some embodiments, the historical fluctuation may be expressed using a variance of historical data of the gas data.

The data type refers to a category of gas data. The data type includes static gas data and dynamic gas data. The static gas data is gas data with small fluctuations. For example, the static gas data may include a cleaning cycle and location for a pipeline maintenance, a pipeline diameter and material, etc. The dynamic gas data is data with large fluctuations. For example, the dynamic gas data may include a gas flow, a gas composition, a gas pressure, a customer complaint, a user repair, etc.

In some embodiments, the smart gas data center may determine gas data whose historical fluctuation is greater than a fluctuation threshold as the dynamic gas data and determine gas data whose historical fluctuation is smaller than or equal to the fluctuation threshold as the static gas data. The fluctuation threshold may be set manually.

In some embodiments, the smart gas data center may store the static gas data and the dynamic gas data in different regions of the smart gas data center database, respectively.

In 222, determining a timeliness feature of the gas data based on the data type and an information feature of the gas data.

The information feature refers to a feature of the information included in the gas data. The information feature may include at least one of a data volume, a collection time, or a data input path of the gas data. In some embodiments, when the gas data originates from a work order distribution center, the information feature also includes a work order execution.

The data input path refers to an input source of the gas data. The data input path may include a collection device and a source object. The collection device refers to a device that collects the gas data. The source object refers to a person or a device from which the gas data originates. For example, gas data 1 is data of device 1 collected by collection device 1.

The work order execution refers to a completed condition of a work order. The work order execution may be expressed numerically. For example, the work order execution may be expressed by 1-5. The larger the number, the better the completion performance of the work order.

The timeliness feature refers to a numerical value, a letter, etc., that reflects an importance degree of the gas data at different time points.

The smart gas data center may determine the timeliness feature of the gas data in a plurality of ways. In some embodiments, the smart gas data center may determine the timeliness feature by looking up a table, etc. Generally, the dynamic gas data is more time-sensitive and the timeliness feature may be prioritized for computation when computational resources are limited.

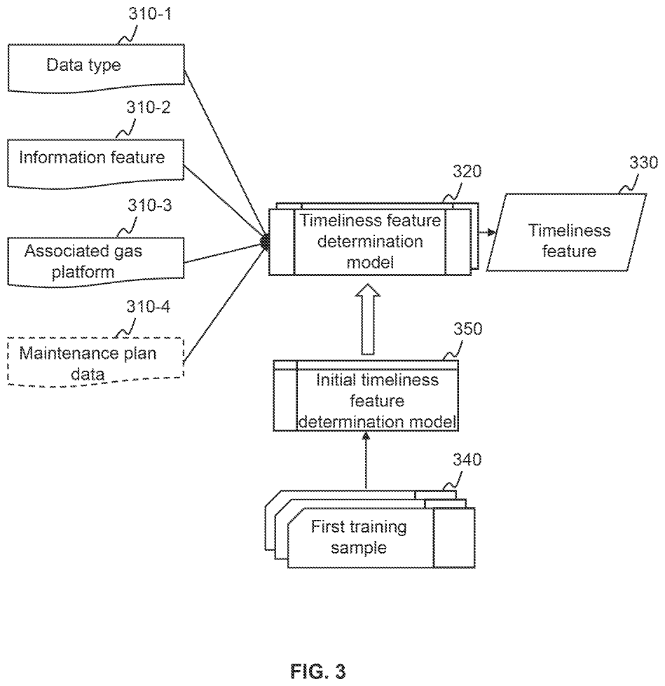

In some embodiments, the smart gas data center may determine the timeliness feature through a timeliness feature determination model. More detailed descriptions regarding the timeliness feature determination model may be found in FIG. 3 and relevant descriptions thereof.

In 223, determining an analytical requirement score of the gas data based on a distributional feature of the gas data.

The distributional feature refers to a statistical feature of a gas data distribution. The distributional feature may at least include a dispersion degree and a concentration degree of the gas data. The dispersion degree refers to a dispersion and difference between the gas data. The concentration degree refers to a tendency and degree to which the gas data converges towards a central value of the gas data.

The analytical requirement score refers to a numerical value that reflects how urgent the gas data needs to be analyzed.

The smart gas data center may determine the analytical requirement score in a plurality of ways. In some embodiments, the analytical requirement score is related to the concentration degree. For example, the analytical requirement score is negatively correlated with the concentration degree. Since an anomaly often occurs with a sudden change of the data, the more concentrated the data, the smaller the fluctuation and sudden change of the data, and the smaller the historical anomaly probability of the data, the smaller probability of the data that needs to be analyzed.

In some embodiments, the smart gas data center may determine the distributional feature based on the gas data and historical gas data corresponding to the gas data, and determine the analytical requirement score based on the distributional feature.

The historical gas data corresponding to the gas data refers to gas data of a historical time period under a same data input path.

In some embodiments, the smart gas data center denotes the dispersion degree of the gas data using a dispersion coefficient of the gas data and a dispersion coefficient of the historical gas data corresponding to the gas data. The dispersion coefficient is a ratio of a standard deviation to a mean. Since the determination of the distributional feature involves comparing dispersion degrees of data with different dimensions or different means, the dispersion degree may be better reflected using a dispersion coefficient that does not need to refer to the mean and is a dimensionless quantity.

In some embodiments, the smart gas data center determines a reciprocal of a variance of standardized gas data and the historical gas data corresponding to the gas data as the concentration degree of the gas data. The gas data includes different types of data. Each type of data differs in nature, dimension, order of magnitude, etc. The standardization refers to an operation of transforming raw data into a standardized value without a dimension and order of magnitude difference to eliminate an impact of different properties of different indicators. For example, the standardization may include a range standardization, a linear scale standardization, etc.

In some embodiments, the analytical requirement score may be a weighted sum of the dispersion degree and the concentration degree of the gas data.

In some embodiments of the present disclosure, the distributional feature may be determined based on the gas data and the historical gas data corresponding to the gas data, and the analytical requirement score may be determined based on the distributional feature. The greater the variation in the gas data, the greater the requirement for the gas data to be analyzed, which increases the accuracy of evaluating the gas data analytical requirement score.

In some embodiments, the analytical requirement score is also related to a historical usage situation of the gas data.

The historical usage situation refers to a total count of times the gas data is called. In some embodiments, the smart gas data center may obtain the historical usage situation of the gas data by performing statistics on the total count of times the gas data is called based on historical access data.

If the historical usage situation exceeds a usage threshold, the greater the historical usage situation, the more likely the gas data is analyzed. In some embodiments, the analytical requirement score of the gas data is a weighted sum of the dispersion degree, the concentration degree, and the historical usage situation.

In some embodiments of the present disclosure, the analytical requirement score is also correlated to the historical usage situation of the gas data, which may better understand a requirement of the smart gas data center for the gas data and improve the accuracy of evaluating the analytical requirement score of the gas data.

In some embodiments, the analytical requirement score is also related to an anomaly degree of the gas data.

The anomaly degree refers to a probability that an anomaly in the gas data occurs. The closer the gas data is to a mean of the historical gas data, the smaller the anomaly degree. In some embodiments, when the gas data is greater than the mean of the historical gas data, the anomaly degree is a ratio of the gas data to the mean of the historical gas data. When the gas data is smaller than the mean of the historical gas data, the anomaly degree is 1 minus the ratio of the gas data to the mean of the historical gas data. If there are a plurality of pieces of gas data, a mean of the gas data may need to be used as the gas data.

The analytical requirement is relatively high since it is necessary to analyze anomalous gas data in a timely manner to determine whether a gas failure occurs. In some embodiments, the analytical requirement score is a weighted sum of the dispersion degree, the concentration degree, the historical usage situation, and the anomaly degree.

In some embodiments of the present disclosure, the analytical requirement score is also related to the anomaly degree of the gas data, which better identifies the analysis requirement of the anomalous gas data and improves the accuracy of evaluating the analytical requirement score of the gas data.

In some embodiments, in response to a determination that the gas data is related to a gas user, the analytical requirement score is also related to personal data of the gas user.

The personal data refers to data related to an identity of the gas user. The personal data may include a user importance level and a report index.

The smart gas data center may determine the user importance level in a plurality of ways. In some embodiments, the smart gas data center may preset user importance levels of different gas users. For example, a user importance level of a regulatory user is greater than a user importance level of an ordinary gas user.

In some embodiments, the user importance level may also be related to recent gas usage and payment data of the user. For example, the user importance level may be a weighted sum of gas usage, a user gas start-up time, and an on-time payment frequency. The user gas start-up time refers to a time when the user starts using gas. The gas usage, the user gas start-up time, and the on-time payment frequency may be obtained from the smart gas user platform 110.

In some embodiments, the repair index is related to a count of repairs initiated by an initiator in the near feature and a reliability degree of the repair. For example, the repair index may be a weighted sum of the count of repairs and the reliability degree of the repair. In order to prevent the influence of malicious repair of the user on the calculation of the timeliness feature, the reliability degree of repair is a ratio of a count of repairs that problems are found after actual repairs to the count of repairs.

In some embodiments, when the gas data is related to the gas user, the analytical requirement score is positively correlated with the user importance level and the report index.

In some embodiments of the present disclosure, in response to a determination that the gas data is related to the gas user, the analytical requirement score is also related to the personal data of the gas user, which can better identify an important gas user and improve the accuracy of evaluating the gas data analytical requirement score.

In 230, determining an execution feature of the smart gas data center based on the timeliness feature of the at least one piece of gas data and the analytical requirement score of the at least one piece of gas data.

The execution feature refers to a specific execution scheme of transmission data. The execution feature includes estimated transmission data transmitted by the smart gas data center to at least one gas platform and an estimated transmission time of the estimated transmission data. For example, the execution feature includes a plurality of sets of estimated transmission data and estimated transmission times corresponding to the estimated transmission data. That is, the estimated transmission data is transmitted at the estimated transmission time corresponding to the estimated transmission data. The at least one gas platform includes a smart gas service platform, a smart gas sensor network platform, and/or a smart gas management platform. More descriptions regarding the smart gas service platform, the smart gas sensor network platform, and the smart gas management platform may be found in FIG. 1 and relevant descriptions thereof.

The estimated transmission data refers to data that needs to be transmitted to the at least one gas platform.

The estimated transmission time refers to a specific time when the estimated transmission data is transmitted to the at least one gas platform.

The smart gas data center may determine the execution feature in a plurality of ways. In some embodiments, the smart gas data center may determine a priority value of the at least one piece of gas data by looking up a table and determine the estimated transmission time (i.e., the execution feature) of the at least one piece of gas data by sorting the at least one piece of gas data based on the priority value of the at least one piece of gas data.

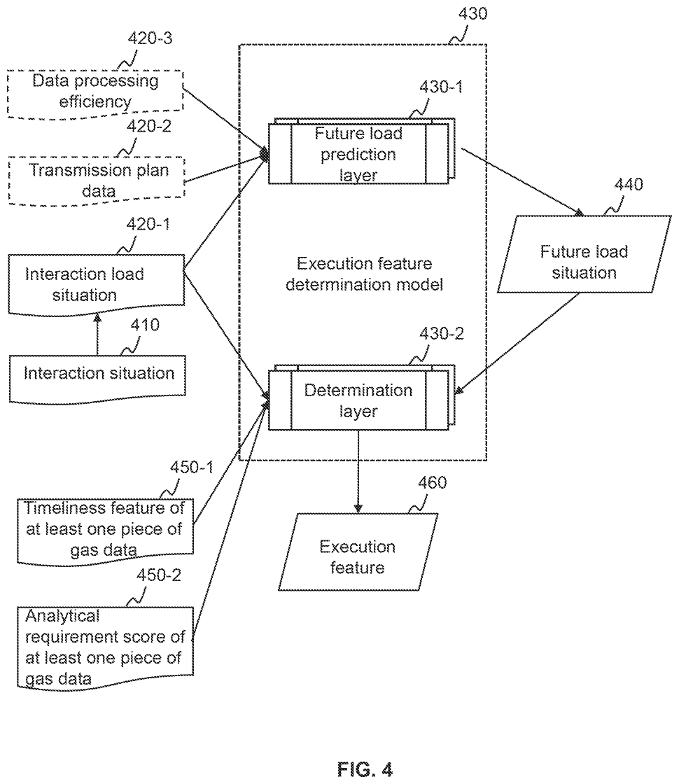

In some embodiments, the smart gas data center may determine the execution feature through an execution feature determination model. More descriptions regarding the execution feature determination model may be found in FIG. 4 and relevant descriptions thereof.

In some embodiments of the present disclosure, the execution feature of the smart gas data center may be determined based on the timeliness feature and the analytical requirement score, which may better control the time of data transmission according to the importance degree of the gas data at different time points, thereby improving the data processing efficiency of the smart gas data center.

It should be noted that the above descriptions of the process is merely provided for the purpose of illustration, and is not intended to limit the scope of application of the present disclosure. For those skilled in the art, various modifications and changes can be made to the process under the guidance of the present disclosure. However, these modifications and changes still remain within the scope of the present disclosure.

FIG. 3 is an exemplary schematic diagram illustrating a process of generating a timeliness feature based on a timeliness feature determination model according to some embodiments of the present disclosure.

In some embodiments, a smart gas data center may first determine an associated gas platform 310-3 of the gas data and determine a timeliness feature 330 based on a data type 310-1, an information feature 310-2, and the associated gas platform 310-3, through the timeliness feature determination model 320.

The associated gas platform refers to an upstream and/or downstream platform of data transmission of the smart gas data center. In some embodiments, the associated gas platform may include a source platform and an outgoing platform. The associated gas platform may be determined based on a gas data transmission process. For example, if the gas data is transmitted to the smart gas data center through a smart gas sensor network platform (i.e., the source platform) and transmitted to a smart gas service platform (i.e., the outgoing platform) after analysis and processing, the smart gas sensor network platform and the smart gas service platform are associated gas platforms.

More detailed descriptions regarding the data type and the information feature may be found in FIG. 2 and relevant descriptions thereof.

The timeliness feature determination model 320 is a machine learning model or a neural network model, such as a recurrent neural network (RNN) model, etc.

In some embodiments, an input of the timeliness feature determination model 320 may include the data type 310-1, the information feature 310-2, and the associated gas platform 310-3, and an output of the timeliness feature determination model 320 may be the timeliness feature 330.

In some embodiments, the input of the timeliness feature determination model 320 also includes maintenance plan data 310-4.

The maintenance plan data refers to a plan made for maintenance of gas devices. The maintenance plan data 310-4 may include at least one of conventional gas maintenance data or feedback gas maintenance data. In some embodiments, a maintenance manner may include repairing, inspecting, cleaning, etc.

The conventional gas maintenance data refers to routine gas device maintenance data, such as periodic maintenance and inspection data. The conventional gas maintenance data may include, but is not limited to, an estimated maintenance time (e.g., a start time, an estimated end time), an estimated maintenance region, and a person estimated to be dispatched (e.g., a person involved in the maintenance).

The feedback gas maintenance data refers to maintenance inspection data initiated by a gas user, a supervisor, and/or a maintainer. For example, after the user initiates a repair request, the maintainer provides the feedback gas maintenance data. In some embodiments, the feedback gas maintenance data may include, but is not limited to, a scheduled maintenance time (scheduled by the initiator), a scheduled maintenance region, the person estimated to be dispatched, an initiator of the maintenance request, and/or an estimated emergency degree.

In some embodiments, the feedback gas maintenance data also includes personal data of the gas user.

More detailed descriptions regarding the personal data may be found in FIG. 2 and relevant descriptions thereof.

In some embodiments of the present disclosure, the personal data of the gas user is considered as a portion of the input of the timeliness feature determination model, which may further improve the data analysis and processing capability of the model.

In some embodiments of the present disclosure, the maintenance plan data is used as input data of the timeliness feature determination model, which may make the output of the model better reflect an actual situation and the timeliness feature of the data.

In some embodiments, the timeliness feature determination model 320 may be obtained by training an initial timeliness feature determination model 350 using a plurality of first training samples 340 with first labels.

In some embodiments, the first training sample(s) 340 may include a sample data type, a sample information feature, and a sample associated gas platform of the sample gas data. The first label(s) may be a timeliness feature corresponding to the first training sample, and the first label(s) may be obtained by manually labeling based on historical actual data.

The timeliness feature is used to indicate an importance degree of the gas data at different time points. In some embodiments, the first label(s) may be determined based on count(s) of times the sample gas data is used at different time points. The more times the sample gas data is used, the more important the first training sample is, and the larger the value(s) of the first label(s). For example, the count(s) of times the sample gas data is used at different time points may be used as the first label(s). As another example, the first label(s) may also be determined by looking up a table based on the count(s) of times the sample gas data is used at different time points and platform(s) on which the sample gas data is used.

The smart gas data center may construct a loss function based on the first labels and an output result of the initial timeliness feature determination model. A parameter of the initial timeliness feature determination model may be iteratively updated through gradient descent or other manners based on the loss function. The model training is completed when a preset condition is met, and a trained timeliness feature determination model is obtained. The preset condition may include convergence of the loss function, a count of iterations reaching a threshold, etc.

In some embodiments, the first training sample(s) 340 may also include sample maintenance plan data.

In some embodiments of the present disclosure, the timeliness feature corresponding to the gas data is obtained through the trained timeliness feature determination model, which may determine reasonable and reliable importance degrees corresponding to different gas data, thereby providing support for the subsequent analysis and processing of the gas data.

FIG. 4 is an exemplary schematic diagram illustrating a process of generating an execution feature based on an execution feature determination model according to some embodiments of the present disclosure.

In some embodiments, a smart gas data center may determine, according to an interaction situation 410 between the smart gas data center and at least one gas platform, an interaction load situation 420-1 of the smart gas data center with data of the at least one gas platform.

The interaction situation 410 refers to a situation that the smart gas data center transmits gas data with other gas platforms. The interaction situation 410 may be determined according to a data transmission situation obtained by statistics of a smart gas management platform. For example, the smart gas management platform 130 may make statistics on an amount of data transmission and a data transmission frequency between the smart gas data center and other gas platforms and determine the interaction situation 410.

The interaction load situation 420-1 refers to a load magnitude of data transmission between the smart gas data center and other gas platforms. Generally, the larger the load, the more severe the interaction load situation. The interaction load situation may be determined based on the interaction situation 410 and a data transmission bandwidth between the smart gas data center and other gas platforms. For example, a ratio of an amount of data transmission reaching the data transmission bandwidth to an amount of data transmission per unit time may be determined based on the interaction situation 410, and the interaction load situation 420-1 may be determined based on the ratio.

In some embodiments, the smart gas data center may determine the execution feature through the execution feature determination model based on the interaction load situation, a timeliness feature of at least one piece of gas data, and an analytical requirement score of the at least one piece of gas data. More detailed descriptions regarding the timeliness feature, the analytical requirement score, and the execution feature, may be found in FIG. 2 and relevant descriptions thereof.

In some embodiments, the execution feature determination model may be a machine learning model, such as a recurrent neural network (RNN) model.

In some embodiments, the execution feature determination model may be obtained by training a plurality of second training samples with second labels. A training manner may include, but is not limited to, a gradient descent manner, etc.

In some embodiments, the second training sample(s) may include a sample interaction load situation of sample gas data, a sample timeliness feature of at least one piece of sample gas data, and a sample analytical requirement score of the at least one piece of sample gas data. The second label(s) may be execution feature(s) corresponding to the second training sample(s). After a plurality of times of data transmission, execution feature(s) with a relatively good execution effect may be used as the second label(s) corresponding to the second training sample(s). The good execution effect refers to a high total transmission value, no adverse feedback (e.g., no untimely platform feedback data transmission), and/or no actual transmission overload during a total time period of the transmission.

The total transmission value may be obtained based on the following equation (1):

T=Σᵢ₌₁ⁿ(Ai*Si+Bi*Fi) (1)

where T denotes the total transmission value, Ai and Bi denote coefficient 1 and coefficient 2 of an i^{th} piece of transmission data, respectively, Si denotes a value of a timeliness feature of the i^{th} piece of transmission data, and Fi denotes an analytical requirement score of the i^{th} piece of transmission data. More descriptions regarding an importance degree of the transmission data at a time point of the transmission and the analytical requirement score may be found in FIG. 2 and relevant descriptions thereof.

As shown in FIG. 4, the execution feature determination model 430 may include a future load prediction layer 430-1 and a determination layer 430-2. The future load prediction layer 430-1 and the determination layer 430-2 may be machine learning models. For example, the future load prediction layer 430-1 may be a long short-term memory (LSTM) model and the determination layer 430-2 may be a recurrent neural network (RNN) model.

In some embodiments, an input of the future load prediction layer 430-1 may include the interaction load situation 420-1, and an output of the future load prediction layer 430-1 may include a future load situation 440.

In some embodiments, an input of the determination layer 430-2 may include the future load situation 440 output by the future load prediction layer 430-1, the interaction load situation 420-1, a timeliness feature 450-1 of at least one piece of gas data, and an analytical requirement score 450-2 of the at least one piece of gas data, and an output of the determination layer 430-2 may include an execution feature 460.

In some embodiments, the input of the future load prediction layer 430-1 may also include transmission plan data 420-2.

The transmission plan data 420-2 refers to a future arrangement plan of data transmission between the smart gas data center and other gas platforms. In some embodiments, the smart gas data center may determine the transmission plan data 420-2 by recalling an existing incoming/outgoing arrangement plan of future data.

In some embodiments of the present disclosure, the transmission plan data is considered as the input of the future load prediction layer, which can improve the accuracy of an prediction result of the future load prediction layer.

In some embodiments, the input of the future load prediction layer 430-1 may also include a data processing efficiency 420-3.

The data processing efficiency 420-3 refers to a numerical value reflecting whether a processing speed of the data center is capable of keeping up with a speed of incoming data. In some embodiments, the data processing efficiency 420-3 may be determined based on the following equation (2):

S=T/(k1*V1+k2*V2+ . . . +kn*Vn) (2)

wherein k1˜kn denote weight coefficients, which may be related to input value scores corresponding to gas platforms, and the higher the input value scores, the greater the weight coefficients; S denotes the data processing efficiency; T denotes a rate at which the data center processes data, and T may be determined based on an average of amounts of data processed by the data center per unit time, which is calculated by the smart gas management platform; V1˜Vn denote data generation speeds of a 1^{st} gas platform to a n^{th} gas platform, respectively, and V1˜Vn may be determined based on an average of amounts of data transmitted by different gas platforms per unit time, which is calculated by the smart gas management platform.

The input value score refers to a score that reflects a total anomaly degree of the gas data transmitted by the gas platforms. The higher the score, the higher the total anomaly degree of the incoming gas data transmitted from the gas platforms during a certain time period. The total anomaly degree refers to a sum of anomaly degrees of the gas data transmitted during the certain time period.

In general, the speed of incoming data transmitted into the data center is directly proportional to the data processing efficiency. When the data processing efficiency is smaller than a data processing efficiency threshold, the gas platform may need to slow down the speed of incoming data transmitted into the data center. When the data processing efficiency is greater than the data processing efficiency threshold, the gas platform may increase the speed of incoming data transmitted into the data center.

It should be understood that, not all of the gas data generated by various platforms is used for calculation of the smart gas data center, and processing preferences of incoming gas data from various platforms are different. In the case that total processing data is limited, the more the gas data processed by a certain gas platform, the greater the weight factor of the gas platform.

In some embodiments of the present disclosure, the smart gas data center uses the data processing efficiency as the input of the model, which can further improve a reliability degree of an output result of the model.

In some embodiments, the executive feature determination model may be obtained by training a plurality of third training samples with third labels. A training manner may include, but is not limited to, a gradient descent manner, etc.

In some embodiments, the output of the future load prediction layer may be the input of the determination layer. The future load prediction layer and the determination layer may be obtained through jointly training based on a plurality of third training samples with third labels.

In some embodiments, the third training sample(s) of the joint training may include the sample interaction load situation of the sample gas data, the sample timeliness feature of the at least one piece of sample gas data, and the sample analytical requirement score of the at least one piece of sample gas data. The third label(s) may be execution feature(s) corresponding to the third training sample(s). The third label(s) may be obtained in a similar way that the second label(s) is obtained.

The smart gas data center inputs the sample interaction load situation into the future load prediction layer and obtains the future load situation output by the future load prediction layer. The smart gas data center uses the future load situation as sample training data, inputs the sample training data and the sample interaction load situation, the sample timeliness feature of the at least one piece of sample gas data, and the sample analytical requirement score of the at least one piece of sample gas data into the determination layer, and obtains the execution feature output by the determination layer. A loss function is constructed based on the third label(s) and the execution feature output by the determination layer, and a parameter of the future load prediction layer and the determination layer may be updated synchronously. A trained future load prediction layer 430-1 and a trained determination layer 430-2 are obtained through parameter updating.

In some embodiments, the third training sample(s) may further include sample transmission plan data and/or sample data processing efficiency.

In some embodiments of the present disclosure, the future load prediction layer and the determination layer are trained jointly, which not only reduces a count of required samples, but also improves the training efficiency. The smart gas data center may quickly identify the execution feature that is relatively realistic and meets timeliness priority analysis based on the trained execution feature determination model, so that the smart gas data center may process different gas data in a graded and hierarchical manner, thereby improving gas data processing efficiency and meeting the requirement.

In some embodiments of the present disclosure, a non-transitory computer-readable storage medium storing computer instructions is provided. When a computer reads the computer instructions in the storage medium, the computer executes the method for managing timeliness of smart gas data.

The embodiments of the present disclosure are merely provided for the purpose of illustration and are not intended to limit the scope of application of the present disclosure. For those skilled in the art, various modifications and changes can be made under the guidance of the present disclosure. These modifications and changes still remain within the scope of the present disclosure.

Certain features, structures, or characteristics of one or more embodiments of the present disclosure may be appropriately combined.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing timeliness of smart gas data, wherein the method is implemented by a smart gas data center, and the method comprises:
obtaining at least one piece of gas data of the smart gas data center periodically;
for any one of the at least one piece of gas data,
determining a data type of the gas data based on a historical fluctuation of the gas data, and categorizing and storing the gas data based on the data type, the data type including static gas data and dynamic gas data;
determining a timeliness feature of the gas data based on the data type and an information feature of the gas data, the timeliness feature indicating an importance degree of the gas data at different time points; and
determining an analytical requirement score of the gas data based on a distributional feature of the gas data, the distributional feature at least including a dispersion degree and a concentration degree of the gas data; and
determining an execution feature of the smart gas data center based on the timeliness feature of the at least one piece of gas data and the analytical requirement score of the at least one piece of gas data, the execution feature including estimated transmission data transmitted by the smart gas data center to at least one gas platform and an estimated transmission time of the estimated transmission data, and the at least one gas platform including a smart gas service platform, a smart gas sensor network platform, or a smart gas management platform.

2. The method of claim 1, wherein the determining a timeliness feature of the gas data based on the data type and an information feature includes:
determining an associated gas platform of the gas data; and
determining the timeliness feature through a timeliness feature determination model based on the data type, the information feature, the associated gas platform, the information feature including at least one of a data volume, a collection time, or a data input path of the gas data, and the timeliness feature determination model being a machine learning model.

3. The method of claim 2, wherein an input of the timeliness feature determination model further includes maintenance plan data, the maintenance plan data including at least one of conventional gas maintenance data or feedback gas maintenance data.

4. The method of claim 3, wherein the feedback gas maintenance data includes personal data of a gas user.

5. The method of claim 1, wherein the determining an analytical requirement score of the gas data based on a distributional feature of the gas data includes:
determining the distributional feature based on the gas data and historical gas data corresponding to the gas data; and
determining the analytical requirement score based on the distributional feature.

6. The method of claim 5, wherein the analytical requirement score is further related to a historical usage situation of the gas data.

7. The method of claim 5, wherein the analytical requirement score is further related to an anomaly degree of the gas data.

8. The method of claim 5, wherein in response to a determination that the gas data is related to a gas user, the analytical requirement score is further related to personal data of the gas user.

9. The method of claim 1, wherein the determining an execution feature of the smart gas data center based on the timeliness feature of the at least one piece of gas data and the analytical requirement score of the at least one piece gas data includes:
determining, according to an interaction situation between the smart gas data center and the at least one gas platform, an interaction load situation of the smart gas data center with data of the at least one gas platform; and
determining the execution feature through an execution feature determination model based on the interaction load situation, the timeliness feature of the at least one piece of gas data, and the analytical requirement score of the at least one piece of gas data, the execution feature determination model being a machine learning model.

10. The method of claim 9, wherein an input of the execution feature determination model further includes transmission plan data.

11. The method of claim 9, wherein the input of the execution feature determination model further includes a data processing efficiency.

12. An Internet of Things (IoT) system for managing timeliness of smart gas data, comprising a smart gas user platform, a smart gas service platform, a smart gas management platform, a smart gas sensor network platform, and a smart gas object platform interacting in sequence, wherein the smart gas management platform includes a smart gas data center, and the smart gas data center is configured to:
obtain at least one piece of gas data of the smart gas data center periodically;
for any one of the at least one piece of gas data,
determine a data type of the gas data based on a historical fluctuation of the gas data and categorizing and storing the gas data based on the data type, the data type including static gas data and dynamic gas data;
determine a timeliness feature of the gas data based on the data type and an information feature of the gas data, the timeliness feature indicating an importance degree of the gas data at different time points; and
determine an analytical requirement score of the gas data based on a distributional feature of the gas data, the distributional feature at least including a dispersion degree and a concentration degree of the gas data; and
determine an execution feature of the smart gas data center based on the timeliness feature of the at least one piece of gas data and the analytical requirement score of the at least one piece of gas data, the execution feature including estimated transmission data transmitted by the smart gas data center to at least one gas platform and an estimated transmission time of the estimated transmission data, and the at least one gas platform including the smart gas service platform, the smart gas sensor network platform, or the smart gas management platform.

13. The IoT system of claim 12, wherein the smart gas management platform includes a gas business management sub-platform, a non-gas business management sub-platform, and the smart gas data center; and
the smart gas data center includes a service information database, a management information database, and a sensor information database, the service information database interacting with the smart gas service platform in both directions, the management information database interacting with the gas business management sub-platform in both directions, the management information database interacting with the non-gas business management sub-platform in both directions, and the sensor information database interacting with the smart gas sensor network platform in both directions.

14. The IoT system of claim 12, wherein the smart gas data center is further configured to:
determine an associated gas platform of the gas data; and
determine the timeliness feature through a timeliness feature determination model based on the data type, the information feature, the associated gas platform, the information feature including at least one of a data volume, a collection time, or a data input path of the gas data, and the timeliness feature determination model being a machine learning model.

15. The IoT system of claim 14, wherein the timeliness feature determination model further comprises maintenance plan data, the maintenance plan data comprising at least one of conventional gas maintenance data, feedback gas maintenance data.

16. The IoT system of claim 15, wherein the feedback gas maintenance data includes personal data of a gas user.

17. The IoT system of claim 12, wherein the smart gas data center is further configured to:
determine the distributional feature based on the gas data and historical gas data corresponding to the gas data; and
determine the analytical requirement score based on the distributional feature.

18. The IoT system of claim 17, wherein the analytical requirement score is further related to a historical usage situation of the gas data.

19. The IoT system of claim 17, wherein the analytical requirement score is further related to an anomaly degree of the gas data.

20. A non-transitory computer-readable storage medium storing computer instructions, wherein when a computer reads the computer instructions in the storage medium, the computer executes the method for managing timeliness of smart gas data of claim 1.
